(19) United States
(12) Patent Application Publication
(10) Pub. No.: US 2026/0351701 A1
(43) Pub. Date: Nov. 5, 2026

(54) Flexible Battery Expansion Sensor for Rechargeable Battery

(71) Applicant: IEE INTERNATIONAL ELECTRONICS & ENGINEERING S.A., Echternach (LU)

(72) Inventors: Andreas OLK, LUXEMBOURG (LU); Laurent LAMESCH, REICHLANGE (LU); Pascal SCHMALEN, JUNGLINSTER (LU); Michael OLK, WELSCHBILLIG-TRÄG (DE); Matthias MASSING, KONZ (DE); Patrick DI MARIO COLA, SERROUVILLE (FR); Thomas STIFTER, TRIER (DE); Lukas WÜRTH, ARLON (BE); Andreas DIEWALD, FELL (DE); Arthur CRETIN, LUXEMBOURG (LU)

(21) Appl. No.: 19/486,823

(22) PCT Filed: May 22, 2024
(86) PCT No.: PCT/EP2024/064059

§ 371 Date: Nov. 21, 2025

(30) Foreign Application Priority Data
May 25, 2023 (LU) LU504307

(51) Int. Cl. H01M 10/48; G01L 1/12; G01L 1/14; H01F 27/28; H01M 50/293

(52) U.S. Cl. CPC H01M 10/482; G01L 1/127; G01L 1/14; H01F 27/2871; H01M 10/486; H01M 50/293

(57) ABSTRACT

A battery pack having a housing, at least a first battery cell in the housing, and at least one expansion sensor. An outer shell of the first battery cell has an electrically conductive material. The sensor is arranged between the electrically conductive material and an abutting surface adjacent to the first battery cell and includes at least one flat inductor circuit arranged on a flexible substrate. The flat inductor circuit is arranged in a contact zone between the first battery cell and the abutting surface, with at least a first compressible buffer layer arranged between the flexible substrate and the electrically conductive material of the outer shell and a detection circuit coupled to the flat inductor circuit via connector lines arranged on the flexible substrate for detecting a change in inductance of the flat inductor circuit.

### TECHNICAL FIELD

The invention relates to a battery expansion sensor for use in a battery pack, a battery pack comprising a plurality of linearly stacked battery cells and at least one such battery expansion sensor, and a method for at least one of detecting upcoming thermal runaway, supporting the evaluating of a state of safety and supporting the evaluating of a state of health of such a battery pack.

### BACKGROUND

Modern batteries are used in a wide range of technological fields. For example, batteries are currently used in electrical devices, music equipment, tools and gardening equipment, as energy (buffer) storage (for household and industrial sites with solar panels and other generators), in vehicles or large-scale industrial facilities, or for remote (off-grid) camps. Regularly, several batteries, respectively battery cells, such as e.g. pouch cells, are arranged within a housing of a battery pack.

In particular in view of present mobility-related technologies, such battery packs represent key elements for storing and providing energy for electrical vehicles (EV), hybrid electric vehicles (HEV), plug-in hybrid vehicles (PHEV) and new energy vehicles (NEV).

During its service life, a battery pack is not only exposed to demanding environmental impacts, such as e.g. heat, cold and humidity, but also to demanding reaction dynamics such as, for example, the frequency and number of charging and de-charging processes. These aspects have an influence on the total and remaining service life and condition of the battery pack. As a result, battery cells and battery packs are subject to aging and degradation processes, which may increase the occurrence of “swelling” or “gassing”.

“Gassing” may generally refer to a phenomenon caused by gas generation inside a battery (cell). Gassing may result from the decomposition of the electrolyte inside the battery and/or be caused by overheating and/or overcharging a battery. A gassing battery cell may swell, break or even explode. “Swelling” generally refers to a volume change of the battery (cell). The swelling may for example be caused by storage and removal processes of lithium ions in and/or on the electrode. Swelling may also be caused by gassing. Swelling leads to a mechanical deformation of the battery cell, which causes pressure forces in and/or on the enclosure of the battery cell and/or the battery pack. In order to compensate swelling, battery manufacturers usually use rigid structures such as metal or hard plastic housings which counter expansions of the housing. Furthermore, the battery manufacturers typically include elastic materials, such as foams, in the stack to absorb the swelling.

An expansion, respectively a displacement or dilatation caused by the occurrence of pressure forces during swelling, may correlate with the so-called “State of Health” (SOH) of a battery pack. “State of health” generally refers to the aging state of a battery pack, which thus represents a measure, respectively an indicator, of the battery pack ability to store and deliver electrical energy in comparison to a new battery pack. The dilatation is also used to determine and/or predict the end of life (EOL) of the battery pack. The EOL generally is used to determine a period in which the battery pack may be safely charged and discharged. The EOL may also be used, like the SOH, as an indicator for indicating the remaining operating time, respectively the remaining service life time, of the battery pack.

In order to enhance the security and reliability of the battery pack in its operation environment, a battery management system (BMS) is often used to determine or estimate the state of charge (SOC) of the respective battery cells of the battery pack as well as the SOH and the EOL. The “state of charge” generally refers to the available capacity which might be expressed or represented as a percentage of its predetermined capacity. In other words, SOC, EOL and SOH are indicators that are determinable by the BMS.

It is further possible to configure the BMS to measure and/or determine further parameters of the battery pack and/or the battery cells, such as e.g. the temperature values and/or the voltages of battery cells. The BMS may have also access to pre-determined and stored specific battery cell characteristic data and measurements, taken from a reference battery cell and/or a reference battery pack. Based on such data, the BMS may, for example, compare stored and/or measured values of a cell with the reference values in order to more precisely determine the different indicators. The BMS may further be configured to monitor the functioning of the respective cells as well as the charging and discharging processes. As a result, the BMS may identify defective cells and switch off such cells. In most cases, the cells have to be replaced when they have been identified as defective; typically, the entire module or pack is replaced.

The useful life, respectively the service life time or remaining operating time, of the battery may be limited by a maximum pressure applied on the mechanical enclosure, respectively the housing, of the battery pack. Usually, the value of the maximum bearable pressure is known by manufacturers. A pressure (force) exceeding the predetermined maximum bearable pressure may lead to a failure of the battery cell, the housing or the entire battery pack. For example, a pressure which is caused by a swelling of a battery cell and which exceeds the predetermined maximum bearable pressure value may result in a breach of the battery cell. For this reason, battery management systems may also be configured to detect swellings.

In order to detect a swelling, common battery management systems use algorithms or complex mechanical devices to perform estimations on the current condition, respectively state, of the battery cell and/or the battery pack. In most existing battery packs, the quantities that are monitored include voltage, charging currents, temperature, and similar. From these quantities, a state of health can be estimated. The use of such algorithms may be based or rely on more or less correct estimation(s) of the EOL indicator, the SOC indicator or the SOH indicator.

The estimation of the expansion of the cell from parameters such as the battery voltage, charging currents, battery temperature, etc. is however not always accurate enough. Several ideas have been proposed to measure the pressure within the battery pack directly, e.g., mechanical sensing mechanism, piezoelectric materials or pressure sensitive thin film materials. A significant hurdle for most of these approaches is, that the sensor should be very flat to be integrated into a battery pack and it should cover a significant area of the battery pack, e.g., circa 10×30 cm for automotive battery packs. Additionally, despite this size, for consumer applications, it needs to be very cost effective. Due to the mechanical requirement, also conventional inductive or capacitive sensors on rigid printed circuit boards (PCBs) are not feasible.

### SUMMARY

It is therefore an object of the invention to provide a flat battery-compatible expansion sensor for use in a battery pack comprising a plurality of linearly stacked battery cells, in particular pouch cells, for reliably sensing an expansion of a battery cell present in the battery pack in support of detecting upcoming thermal runaway and/or evaluating state of safety (SOS) and/or state of health (SOH) of the battery pack.

In one aspect of the present invention, the object is achieved by a battery pack comprising a housing, at least a first battery cell arranged within said housing and at least one expansion sensor, wherein an outer shell of said first battery cell comprises an electrically conductive material. The battery cell may of any suitable type with adapted design, such as in particular a pouch cell or e.g. a prismatic cell or the like. The at least one expansion sensor is arranged between the electrically conductive material of said outer shell of said first battery cell and an abutting surface adjacent to said first battery cell. The at least one expansion sensor comprises at least one flat inductor circuit arranged on a flexible substrate, said at least one flat inductor circuit being arranged in a contact zone between the first battery cell and said abutting surface adjacent to said first battery cell, at least a first compressible buffer layer arranged between the flexible substrate with the inductor circuit and the electrically conductive material of said outer shell of said first battery cell and a detection circuit coupled to said at least one flat inductor circuit by means of respective connector lines arranged on said flexible substrate for detecting a change in inductance of said at least one flat inductor circuit.

It is noted that the outer shell of the battery cells in conventional battery packs e.g. for electric vehicles consist of a conductive material. In most common pouch cells for instance, this is a thin sheet of aluminum foil laminated onto protective PE or PT films. This conductive property of the pouch cell outer shell can be advantageously used to detect the expansion of the battery cell in battery packs by measuring the displacement of an battery cell wall in the proximity of the sensor using flexible electric circuits which are sensitive to conductive material, such as flat inductor circuits.

Key aspects of the sensor architecture are a flat topography and flexible circuit design that is suitable to be placed in between cells at high pressure, without causing damage/degradation of the cells during the lifetime of the battery. In this context, it is noted that a “flat inductor circuit” is to be understood as an inductor circuit, in which the conductor lines forming the shape of coils or spirals of the inductor circuit are arranged flatly in the same plane on the substrate.

The first compressible buffer layer acts as a compressible spacer between the flexible substrate with the inductor circuit and the electrically conductive material of said outer shell of said first battery cell. The compressible buffer layer, or preferably two compressible buffer layers, one on each side of the flexible substrate with the inductor circuit, acts or act as a compression pads to ensure a slight compression in a newly built condition, and further to allow for expansion and contraction during charging, discharging and aging. For the material used in such compressible buffer layer, a stress-strain curve showing a low compressive stress across a broad range of compressive strain is desirable. A known example for such a material is a fine-pored foam, such as e.g. a micro-cellular polyurethane foam. It will be appreciated that the compressible buffer layer or layers also act as insulating layers, preventing a direct contact between the conductive material of the battery cell outer shell and the flat inductor circuits.

It will be appreciated, that the expansion sensor described above provides the prerequisites for continuous monitoring of the expansion of the battery cell or cells within the battery pack and thus can support in evaluating the state of health of the battery cells by applying one of well-known suitable evaluation methods. The proposed sensor accordingly can enable an early detection of an occurrence of thermal runaway, and can support in taking measures for potential prevention by precise sensing of a current compression load.

Thermal runaway is known to be one of the most serious failure modes of a rechargeable traction battery. Details are, for instance, described in Koch, Sascha et al. “Fast Thermal Runaway Detection for Lithium-Ion Cells in Large Scale Traction Batteries.” (Batteries 2018, 4(2), 16; DOI: 10.3390/batteries4020016). Thermal runaway of single cells within a large-scale lithium-ion battery pack is a well-known risk that can lead to critical situations if no counter measures are taken in today's lithium-ion traction batteries for battery electric vehicles (BEVs), plug-in hybrid electric vehicles (PHEV) and hybrid electric vehicles (HEVs). Fast and reliable detection of faulty cells undergoing thermal runaway within the lithium-ion battery is therefore a key factor in battery designs for comprehensive passenger safety.

It will be appreciated, that the expansion sensor disclosed herein is suitable to be used in batteries in a wide range of technological fields, such as batteries used in electrical devices, music equipment, tools and gardening equipment, as energy (buffer) storage or large-scale industrial facilities or for remote (off-grid) camps. The expansion sensor is in particular advantageously employable in battery packs for automotive applications. The term “automotive”, as used in the present patent application, shall particularly be understood as being suitable for use in vehicles including passenger cars, trucks, semi-trailer trucks and buses.

As already indicated above, the at least one expansion sensor comprises a second compressible buffer layer arranged between the flexible substrate with the inductor circuit and said abutting surface. In such an embodiment, the flexible substrate with the inductor circuit is sandwiched between the two compressible buffer layers. The buffer layers on both sides of the flexible substrate with the inductor circuit advantageously protect both the flexible substrate with the inductor circuit and the adjacent battery cells by preventing excessive deformation of the flexible substrate and direct contact of inductor circuit elements with the battery cells.

The first compressible buffer layer and/or the second compressible buffer layer preferably comprise a compressible foam with a magnetic filler material, such as ferrite particles/powder. Under compression of the foam, the effective permittivity is increased. Similarly, the density of the said magnetic filler will increase, i.e. the effective permittivity of the foam will increase. This effect can be used to tailor the response/sensitivity. In other words, these measures increase the possible range of buffer layer thicknesses where the sensor performs well (high sensitivity, stable signal).

In a preferred embodiment, the at least one expansion sensor comprises a plurality of flat inductor circuits arranged at individual locations on said flexible substrate in said contact zone, each flat inductor circuit being coupled to said detection circuit by means of respective connector lines arranged on said flexible substrate. The inductor circuits are preferably more or less evenly distributed over the contact zone so that an expansion of the battery cell resp. the displacement of the outer shell of the battery may be reliably detected even if such a displacement occurs only locally due to an irregular expansion of the battery cell.

In embodiments, the flexible substrate comprises a sensor portion to be arranged in said contact zone and a connecting tab extending from said sensor portion outwardly from said contact, and wherein said detection circuit is arranged on said connecting tab outside of said contact zone between the first battery cell and said abutting surface. The detection circuit, and any further discrete electric components like integrated circuits (ICs) and lumped elements like capacitors, are advantageously arranged on or coupled to the connection tab so that that detection circuit and the further electrical components are arranged outside of the contact zone between the first battery cell and said abutting surface and thus not compressed within the battery cell stack-up. This arrangement advantageously respects the flatness requirement for any part of the sensor which is to be placed between and in contact with the battery cells.

In embodiments, the flat inductor circuits and/or the connector lines are formed on the flexible substrate by screen printing, inkjet printing, aerosol printing or similar thick film processes, or as laminates. Conductor lines can be deposited for instance with screen printing, inkjet printing, aerosol printing or similar thick film processes. By making the electric lines of the plurality of electric lines from electrically conductive ink, an application of high-precision manufacturing methods such as screen printing and ink jet printing is facilitated, resulting in low production tolerances and little material waste. Due to the comparably large size of the circuit, a conductor with a very high conductivity is favorable. If the conductivity is too low, ohmic losses will attenuate the resonance and thus the change of inductance is harder to be detected. Printing inks with a high content of silver particles, preferably nanoparticles can be used to prevent the attenuation. Alternatively, etched laminates or similar processes which enable near bulk metal conductivity can be used. To optimize cost, printed layers can be used in conjunction with laminates (e.g. etched conductive laminates or dielectric laminates cut by laser).

In embodiments of the invention, said at least one expansion sensor further comprises two conductive electrode pads arranged adjacent to each other on said flexible substrate in said contact zone between the first battery cell and said abutting surface, each of said electrode pads being coupled to said detection circuit by means of respective connector lines arranged on said flexible substrate. In such an embodiment the detection circuit is further configured to detect a capacitance change between said electrode pads and/or a capacitance change between one of said electrode pads and said at least one flat inductor circuit. The electrode pads couple to each other via the conductive battery cell outer shell which is adjacent to the pads (shunt mode). Therefore, a capacitive measurement with the two electrode pads can provide an additional signal to detect cell expansion. Since the mutual capacitance is high when the electrodes come closer to the battery cell wall, it gives a good signal for small battery cell spacings, while the inductive-type measurement provides a more stable signal for larger spacings. Therefore, aside from detecting different regions of the cell, the two measurement principles are complementary and provide (after fusion) a quite stable and accurate signal.

A third type of measurement can be done by keeping (at least) one of the contact lines to an inductor circuit open and using the conductor surface of a (at least one) inductor circuit as a capacitive electrode.

It will be appreciated, that the abutting surface may be formed by an inner wall of the battery housing, in which case the expansion sensor is arranged between the outermost battery cell of the battery pack and the battery housing. In a preferred embodiment, the battery pack comprises at least a second battery cell adjacent to said first battery cell, and the abutting surface is formed by said second battery cell. In this case the at least one expansion sensor is arranged between said first battery cell and said second battery cell.

A problem of printed conductor lines is the change of the DC resistance when ageing. The change in DC resistance can introduce significant change in the frequency dependent impedance characteristics and will thus lead to errors in the displacement estimation. In a further embodiment, said detection circuit is configured to determine a DC resistance of said at least one inductor circuit. In this embodiment, the DC resistance may be measured and used as additional term to evaluate the displacement. It is used e.g. used as a correction term that is carefully modelled in aging experiments.

In order to increase the detection accuracy, it is advantageous, if said detector circuit is configured for, in a first mode of operation, individually detecting a change in inductance of at least two flat inductor circuits of said plurality of flat inductor circuits and for, in a second mode of operation, detecting a capacitance change between said at least two flat inductor circuits of said plurality of flat inductor circuits.

It will be appreciated that the flexible substrate may be made from a planar foil of plastic material that is selected from a large group of plastic materials formed e.g. by polyethylene terephthalate PET, polyimide PI, polyetherimide PEI, polyethylene naphthalate PEN, polyoxymethylene POM, polyamide PA, polyphthalamide PPA, polyether ether ketone PEEK, polycarbonate PC, poly(methyl methacrylate) PMMA, and combinations of at least two of these plastic materials. These plastic materials can allow for easy manufacturing, and durable, cost-efficient dielectric carrier members of low manufacturing tolerances can be provided in this way.

The present invention also relates to a method for at least one of detecting upcoming thermal runaway, supporting the evaluating of a state of safety and supporting the evaluating of a state of health of a battery pack as disclosed above. This method comprises at least the following steps:
detecting an expansion of a battery cell and/or a displacement of the outer shell of a battery cell, wherein said detecting an expansion of said battery cell and/or a displacement of the outer shell of said battery cell comprises at least the step of detecting a change in inductance of at least one flat inductor circuit of said at least one expansion sensor by said detection circuit;
evaluating at least one of a status of an upcoming thermal runaway, a state of safety and a state of health of the battery pack based on at least said expansion of said first battery cell and/or displacement of the outer shell of said first battery cell.

It will be appreciated, that the invention is not limited to the detection of the expansion of only a specific battery cell in the row of cells, but the method enables to detect the expansion of any cell in the row. In fact, expansion of any cell in the pack would lead to increased pressure within the battery pack and thus to a compression of the buffer layer.

In embodiments, said detecting an expansion of said battery cell and/or a displacement of the outer shell of said battery cell further comprises the steps of
individually detecting a change in inductance of at least two flat inductor circuits;
detecting a capacitance change between said at least two flat inductor circuits.

In embodiments, where the at least one expansion sensor further comprises two conductive electrode pads arranged adjacent to each other on said flexible substrate in said contact zone between the first battery cell and said abutting surface; the step of detecting an expansion of said first battery cell and/or a displacement of the outer shell of said first battery cell may further comprise the step of detecting a capacitance change between said electrode pads and/or a capacitance change between one of said electrode pads and said at least one flat inductor circuit.

In a further embodiment, that detecting an expansion of said first battery cell and/or a displacement of the outer shell of said first battery cell further comprises the step of determining a DC resistance of said at least one inductor circuit. This DC resistance may be used as a correction parameter for the detection of the battery cell expansion.

The present invention, in at least some embodiments, thus provides an expansion sensor in a battery pack, with a specific design with distinct geometry that is compatible to cost effective manufacturing techniques (screen printing) for electronic circuits of large size, e.g. here 300 mm in one dimension, like typical pouch cells. Disclosed are also details on how to manufacture such a comparably large circuit with low ohmic losses. Alternatively, the combination of high loss printed inductors with a more specific measurement device for complex impedance evaluation can be used (i.e. not a commercial IC for eddy current sensors, specific oscillator). The disclosed sensor architecture provides a cost-effective solution where other methods like flex PCBs or rigid PCBs are not feasible.

It will be appreciated, that in embodiments of the invention, the expansion sensor could include at least one reference inductor and/or capacitor which is not located in the compressible area. The measurement of this reference inductor/capacitor can give additional information in such an embodiment that can help to compensate for aging. Since the at least one reference inductor/capacitor would not change its geometry, changes in its response can be attributed to aging of the conductor lines, dielectric, and other materials in the proximity.

These and other aspects of the invention will be apparent from and elucidated with reference to the embodiments described hereinafter.

### BRIEF DESCRIPTION OF THE DRAWINGS

Further details and advantages of the present invention will be apparent from the following detailed description of not limiting embodiments with reference to the attached drawing, wherein:

FIG. 1 schematically shows a sectional view of a battery pack;

FIG. 2 is a schematic perspective partial view on an expansion sensor arranged between two battery cells,

FIG. 3 is a schematic illustration of an embodiment of the inductor circuits of an expansion sensor;

FIG. 4 shows an enlarged view of a flat conductor circuit of FIG. 3;

FIG. 5 is a schematic illustration of a second embodiment of an expansion sensor;

FIG. 6 is a schematic illustration of a third embodiment of an expansion sensor;

FIG. 7 illustrates the principle of eddy current displacement measurements; and

FIG. 8 illustrates the principle combined inductive and capacitive measurements.

In the different figures, the same parts are always provided with the same reference symbols or numerals, respectively. Thus, they are usually only described once.

### DETAILED DESCRIPTION

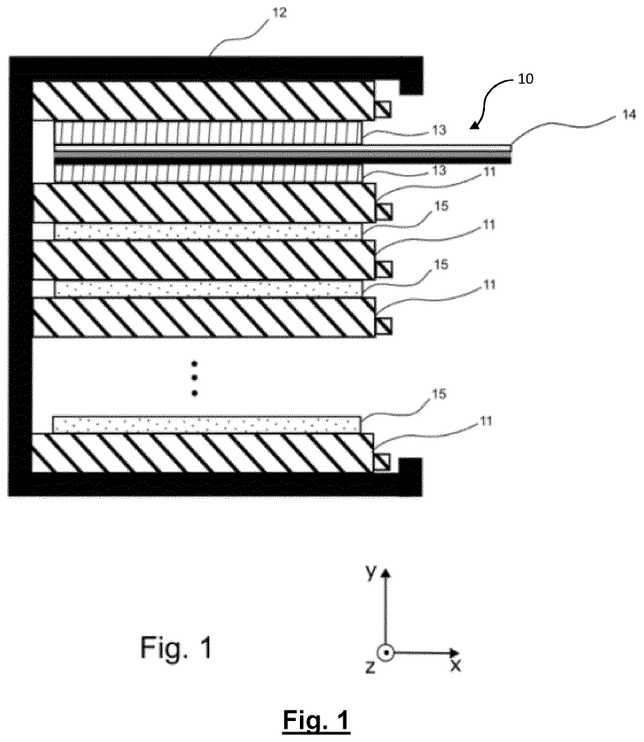

A first embodiment of the invention will be described in the following with reference to FIGS. 1 to 4.

An arrangement of battery cells 11 into a battery stack is schematically represented in FIG. 1. To make efficient use of the proposed cell expansion sensor 10, the sensor 10 is integrated into a stack of several battery cells 11 which are all mounted into a rigid housing 12. The battery cells 11 are stacked up into one direction (here vertically, i.e., y-direction).

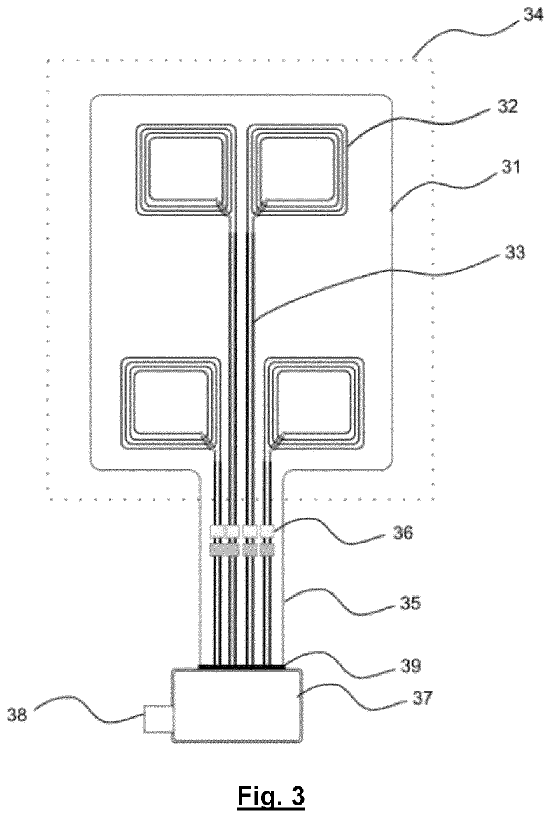

The sensor 10 comprises a sensing layer 14 including a thin flexible dielectric substrate 31, 35 (see also FIG. 3) equipped one or more layers of structured conductive and dielectric material forming flat inductor circuits 32. The sensor 10 further comprises two compressible buffer layers 13, which are arranged on either side of (above and below) the flexible dielectric substrate 31 with the flat inductor circuits 32 applied thereon, i.e. on either side of the sensing layer.

The buffer layers 13 are made e.g. of a fine-pored foam which is compressible, such as e.g. a micro-cellular polyurethane foam.

In the shown embodiment, the sensor 10 is placed in between two of the battery cells 11 such that the buffer layers 13 are in contact with the walls of the respective battery cells 11. The remaining battery cells 11 are separated by respective intermediate layers 15 which can for instance be an adhesive and/or a further compression pad.

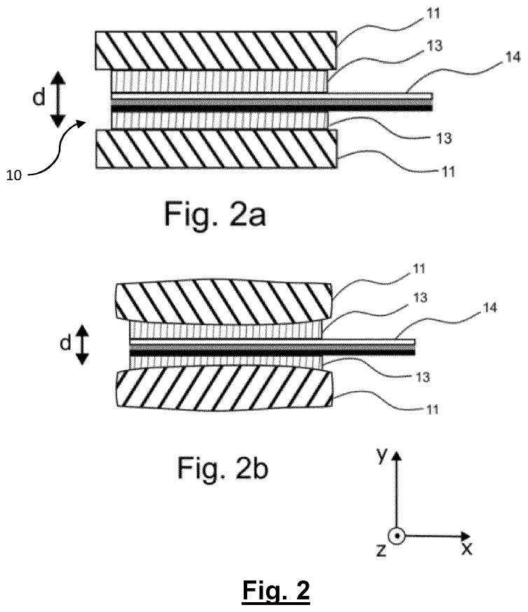

FIG. 2 is a schematic perspective partial view on an expansion sensor 10 arranged between two battery cells 11. FIG. 2a shows the battery cells 11 in a non-expanded state, while FIG. 2b shows the deformation of a part of the layer stack-up during cell expansion. Cells 11 deform in a way that their side walls approach the sensor layer 14. The deformation of the cell 11 can result in a symmetric pillow shape or, depending on the inside structure of the cell, it can be asymmetrical resulting in an uneven change of the distance d throughout the xz-plane. In the proposed application, it is important that the sensor layer 14 is flexible and very flat. Edges, bumps, and other topological irregularities could degrade or damage the cell 11 when being compressed. The outer shell of all battery cells 11 consists of a conductive material. In most common pouch cells for instance, this is a thin sheet of aluminum foil laminated onto protective PE or PT films.

FIG. 3 is a schematic illustration of an embodiment of the inductor circuits 32 of the sensor layer 14 of an expansion sensor 10. A flexible substrate 31, 35 is provided and used as support structure for the electric circuit. This substrate comprises a sensor portion 31 that has a similar size than the battery cells 11 and a connecting tab 35 extending from said sensor portion 31. The electric circuit comprises several printed inductors 32, i.e., conductor lines in the shape of coils or spirals 32. These inductors 32 are optimized to give a specific inductance in proximity to the conductive outer shell of the battery cells 11.

The electric circuit also comprises contact lines or feeding lines 33 which connect the inductors 32 to a control unit 37. If the sensor is arranged between two battery cells 11, the stack-up of cells covers the region marked by the dotted rectangle 34, i.e. the contact zone. The sensor part shown in the lower part of FIG. 3 (outside of the dotted rectangle 34), i.e. among others the connecting tab 35 is not compressed within the battery cell stack-up. Electric components 36 like integrated circuits (ICs) and lumped elements like capacitors can thus be placed on this lower part of the sensor. These components 36 are for instance SMD type (surface mount device) elements. Due to the flatness requirements of the sensor layer 14 within the contact zone 34, these components cannot be placed inside region 34. The control unit 37 comprises e.g. an outer plastic housing, a printed circuit board with the required control electronics, power supply and related. Additionally, it includes an interconnection 39 to the remaining flexible circuit structure and a connector 38 to a central processing unit (not shown).

In the embodiment of FIG. 3, the sensor 10 comprises four LC circuits. Here, four separate circuits allow to detect thickness variations in the stack-up at four different regions in the plane of the sensor portion 31 of the flexible substrate, these are the inner circles of the inductors 32.

Due to the occurrence of eddy currents, the inductance of the coils 32 is lowered significantly when conductive surfaces such as the outer shell of the battery cell 11 approach the coil. Therefore, expansion, and other deformations of the cell 11 are causing a shift of the resonant frequency. Additionally, the real part of the impedance changes. Both of these effects can be used to estimate a displacement of the cell wall.

Due the comparably large size of the circuit, high ohmic losses may occur and the LC resonance may be strongly attenuated. It is therefore advantageous, to carefully optimize the circuit design and drastically reducing the ohmic losses using a conductor with near bulk metal conductivity.

The flexible substrate can for instance be made from polyethylene (PE), polyimide or PT foil. Conductor lines can be deposited for instance with screen printing, inkjet printing, aerosol printing or similar thick film processes. Due to the comparably large size of the circuit, a conductor with a very high conductivity is favorable. If the conductivity is too low, ohmic losses will attenuate the resonance and will be more difficult to be detected. Printing inks with a high content of silver particles, preferably nanoparticles can be used to prevent the attenuation. Alternatively, etched laminates or similar processes which enable near bulk metal conductivity can be used. To optimize cost, printed layers can be used in conjunction with laminates (e.g. etched conductive laminates or dielectric laminates cut by laser).

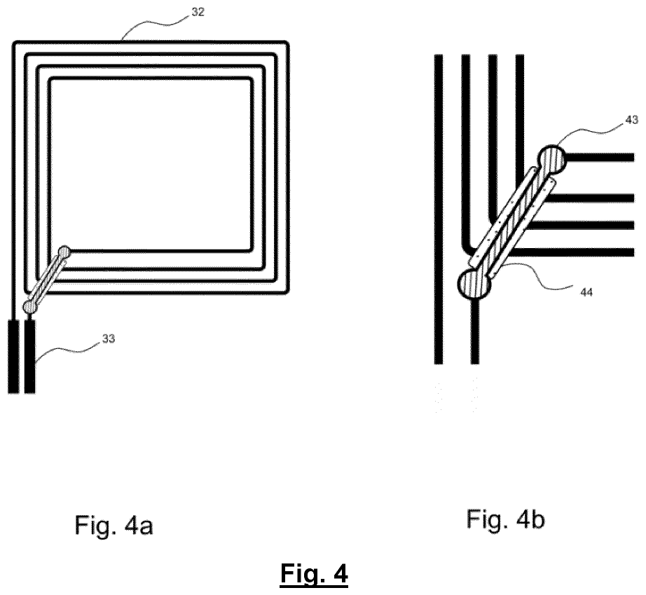

In order to connect a coil 32 to the feeding lines 33 without creating a short on the inner loops, a multilayer printing/deposition process is required. This detail is shown in FIG. 4. In the case of the shown embodiment, this is done using a small dielectric patch 44 printed on top of the conductor lines of the coil 32. In a subsequent step, conductor lines in the shape of dumbbells 43 are printed on top of both 44 and 32. Since the third print includes just short conductor lines 43, here, the conductivity is not as crucial and most cost-efficient techniques can be used. The contact surface of 43 and 32 is preferably enlarged to reduce ohmic contact resistance and to reduce the geometrical tolerances. To further avoid ohmic losses, the contact lines 33 are preferably significantly wider than the conductor lines of the coil 32 which have a specific linewidth required to get an optimal inductance (FIG. 4a).

A problem of printed conductor lines is the change of the DC resistance when ageing. The change in DC resistance can introduce significant change in the frequency dependent impedance characteristics and will thus lead to errors in the displacement estimation. Therefore, in a preferred embodiment, the DC resistance is measured and used as additional term to evaluate the displacement. It is used in correction term that is carefully modelled in aging experiments.

In at least some preferred embodiments of the invention, the entire sensor layer 14 including the structured conductor lines 32, 33, 43 and dielectric patches 44 are flat in order not to harm the cell when under pressure. By describing the sensor as flat, the inventors refer to thickness variations of <30 μm within the area marked by the dotted rectangle 34. Furthermore, the flat laminated sensor enables a cost-effective assembly, simple integration and adaptation to the battery packs.

Exemplary dimensions and other parameters the shown embodiment may be as shown in Table 1:

TABLE 1

| Size of cells (dx, dy, dz) | (300 mm, 20 mm, 140 mm) | |
|---|---|---|
| Thickness of flexible substrate 31 | 100 | μm |
| Diameter of conductive coils 32 | 70 | mm |
| Thickness of printed conductor lines | 10 | μm |
| Resonant frequency | 10-20 | MHz |
| Linewidth feeding lines 33 | 1 | mm |
| Linewidth coil | 200 | μm |

For other embodiments, the resonant frequency might be within the range 100 kHz-50 MHz. The thickness of the printed conductor lines might be within the range 1-30 μm. Other parameters can vary as well, would remain however in the same order of magnitude.

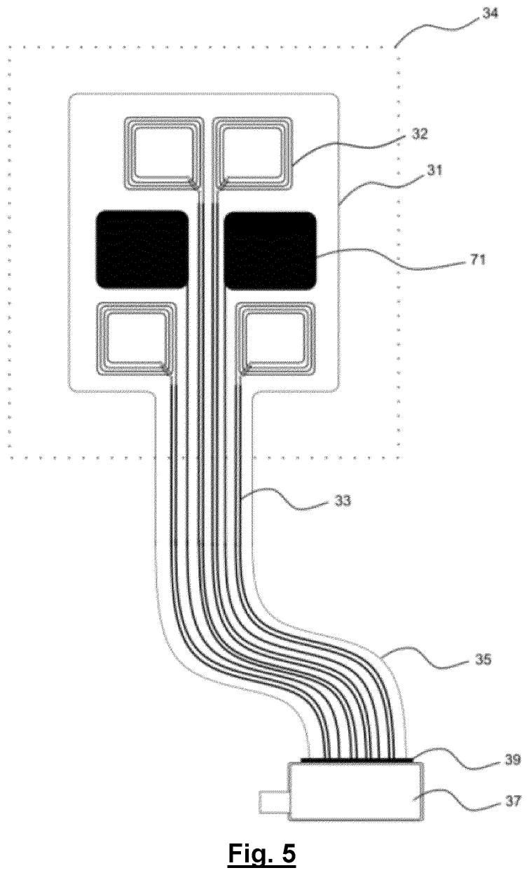

FIG. 5 illustrates a different embodiment of the sensor layer 14. Similar to the embodiment of FIG. 3, the sensor layer of the embodiment of FIG. 5 comprises a flexible substrate 31, 35, several printed inductors 32, contact lines 33, a region 34 which is compressed in between at least two battery cells 11 and two buffer layers 13. The shape of the flexible part of the sensor comprises a connecting tab or tail 35 which will be placed outside the compressed region 34. This connecting tab 35 is shaped to simplify the integration in a battery pack. In this particular case, it is comparably long (35 cm) and forms an S shape. The end of the tail is connected to the control unit 37 using an interconnection structure 39 to connect the feeding lines 33 to the electronic unit therein. With these features, an inductive-type measurement may be performed in a similar way as with the sensing layer 14 illustrated in FIG. 3.

In addition to the circuits with printed inductors 32, two conductive electrode pads 71 are printed on the substrate 31. These electrode pads 71 are also connected to the control unit 37 by respective contact lines. The electrode pads 71 couple to each other via the battery cell 11 walls which are in proximity (shunt mode). Therefore, a capacitive measurement with the two electrode pads 71 can provide an additional signal to detect cell expansion. Since the mutual capacitance is high when the electrode pads 71 come closer to the battery cell wall, a capacitive measurement gives a good signal for small battery cell spacings d. As described above the inductive-type measurement provides a more stable signal for larger spacings d. Therefore, aside from detecting different regions of the cell 11, the two measurement principles are complementary and provide (after fusion) a quite stable and accurate signal.

It will be appreciated that a further type of measurement can be performed by keeping (at least) one of the contact lines 33 to an inductor coil 32 open and using the conductor surface of a (at least one) coil 32 as a capacitive electrode.

Using specific parameterized algorithms or machine learning, the distinct combination of displacement measurements can help to provide a signal which is robust against aging effects. This is of particular importance applications where long lifetimes of the sensor must be guaranteed, e.g., in the automotive sector and similar.

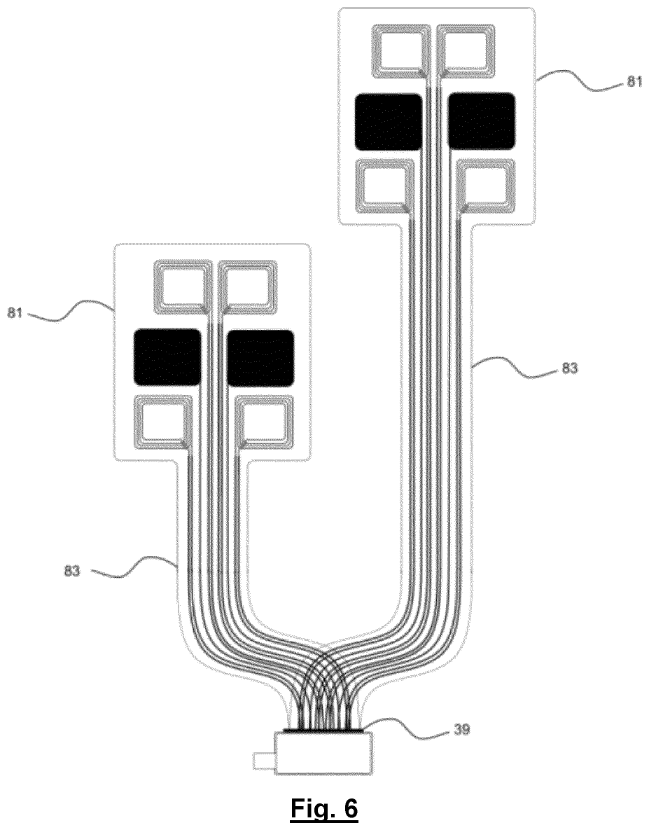

FIG. 6 illustrates the benefit of the disclosed embodiments with regard to the integration of the sensor. In this case, two flexible sensor layers 81 equipped with the same electronic components but with different outline are connected to just one control unit 39. The two sensors could be integrated into two different battery packs where battery cell expansion is detected independently. Using printed electronics manufacturing, such comparably large and flexible sensors can be created at low cost. Including the longer tail on the right side 83, this embodiment has an overall length of 1 m.

It will be appreciated, that with the different embodiments disclosed above, a way of controlling the extension of the magnetic field around the inductor is using magnetic filler (such as ferrite particles/powder) in the buffer layer foam. This will increase the permeability and result in a more moderate interaction with the metal in the proximity (more moderate eddy currents). It can thus help to control the attenuation of the resonance and gives more design flexibility when choosing the foam thickness. Under compression of the foam, the effective permittivity is increased. Similarly, the density of the said magnetic filler will increase, i.e. the effective permittivity of the foam will increase. This effect can be used to tailor the response/sensitivity. For instance, it can help to linearize the response. Similarly, the permittivity of the foam can be adapted in order to manipulate the distance behavior of the capacitive sensing mechanism. In other words, these measures increase the possible range of buffer layer thicknesses where the sensor performs well (high sensitivity, stable signal).

The principle of sensing a distance between an inductor coil and a metal sheet is known in the art, and it is often referred to as eddy current proximity sensor, inductive displacement/position sensor or similar acronyms. Due to the requirement of low ohmic losses and high inductance, these state-of-the-art inductive sensors are typically fabricated either using printed circuit technology with highly conductive etched copper traces and coil diameters of <10 mm or they are fabricated in a non-planar form using copper wires (e.g., rotational speed sensors).

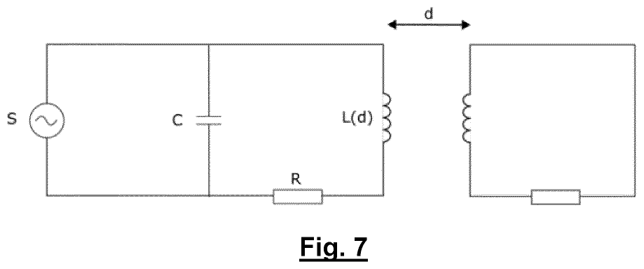

The measurement principle for an inductive type sensor or a combined capacitive/inductive-type sensor is described in more detail using equivalent circuit representations. In FIG. 7, the principle of common eddy current displacement sensors is shown. Here, a parallel like circuit is driven by a resonant circuit driver (marked with S). A metal object is represented as second circuit on the right-hand side. When reducing the distance d between the two, due to eddy currents on the metal object, the inductance L in the parallel like circuit is effectively reduced resulting in a change of the resonant frequency.

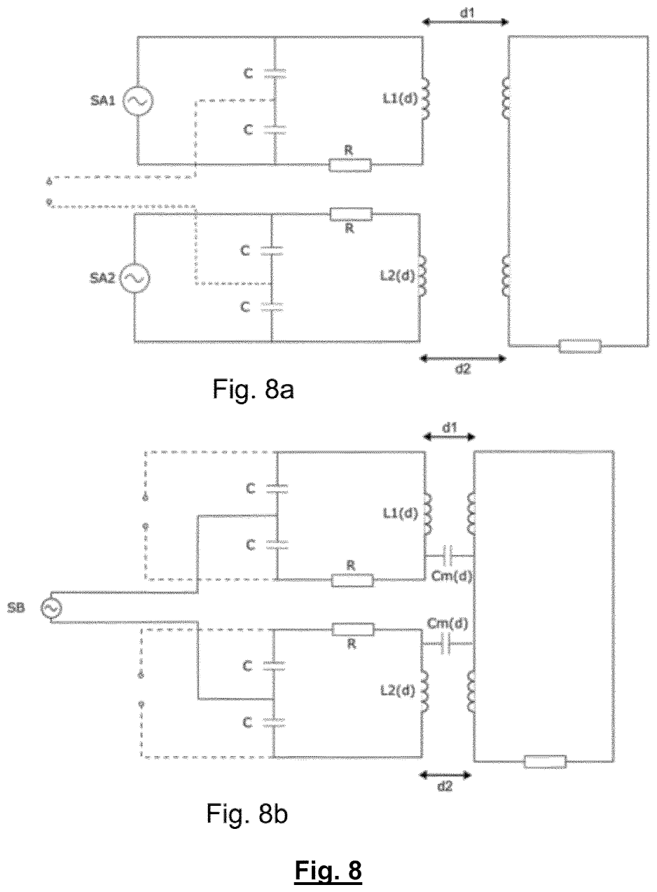

FIG. 8 illustrates a sensing method, in which the common eddy current displacement measurement is combined with capacitive measurements in a specific way. In a first step (FIG. 10a), two parallel like resonant circuits are driven by independent circuit driver SA1 and SA2 respectively. Two contact lines in dashed style are kept open. The metallic object, in this case the battery cell walls are represented by the circuit on the right-hand side. A variation of the distances near the inductances L1 and L2 results in a change of the resonant frequency of each circuit and it can be detected by SA1 and SA2 respectively. In a second step (FIG. 10b), SA1 and SA2 are disconnected, and the circuit is driven by SB to perform a capacitive-type measurement. In this second measurement, the capacitive coupling to the battery cell walls is more important and can be detected with SB.

Similar circuit configurations are possible where predominantly inductive and predominantly capacitive sensing is used in a sequential manner using several sources or circuit drivers and switches.

1. A battery pack comprising a housing, at least a first battery cell arranged within said housing and at least one expansion sensor,
wherein an outer shell of said first battery cell comprises an electrically conductive material;
wherein said at least one expansion sensor is arranged between the electrically conductive material of said outer shell of said first battery cell and an abutting surface adjacent to said first battery cell;
wherein said at least one expansion sensor comprises at least one flat inductor circuit arranged on a flexible substrate, said at least one flat inductor circuit being arranged in a contact zone between the first battery cell and said abutting surface adjacent to said first battery cell, at least a first compressible buffer layer arranged between the flexible substrate with the inductor circuit and the electrically conductive material of said outer shell of said first battery cell and a detection circuit coupled to said at least one flat inductor circuit via connector lines arranged on said flexible substrate, wherein said detection circuit is configured to detect a change in inductance of said at least one flat inductor circuit.

2. A battery pack according to claim 1, wherein said at least one expansion sensor comprises a second compressible buffer layer arranged between the flexible substrate with the inductor circuit and said abutting surface.

3. A battery pack according to claim 1, wherein the at least one expansion sensor comprises a plurality of flat inductor circuits arranged at individual locations on said flexible substrate in said contact zone, each flat inductor circuit being coupled to said detection circuit via respective connector lines arranged on said flexible substrate.

4. A battery pack according to claim 1, wherein said flexible substrate comprises a sensor portion to be arranged in said contact zone and a connecting tab extending from said sensor portion outwardly from said contact zone, and wherein said detection circuit is arranged on said connecting tab outside of said contact zone between the first battery cell and said abutting surface.

5. A battery pack according to claim 1, wherein the flat inductor circuits and/or the connector lines are formed on the flexible substrate by screen printing, inkjet printing, aerosol printing or similar thick film processes, or as laminates.

6. A battery pack according to claim 1, wherein said at least one expansion sensor further comprises two conductive electrode pads arranged adjacent to each other on said flexible substrate in said contact zone between the first battery cell and said abutting surface, each of said electrode pads being coupled to said detection circuit via respective connector lines arranged on said flexible substrate; and wherein said detection circuit is further configured to detect a capacitance change between said electrode pads and/or a capacitance change between one of said electrode pads and said at least one flat inductor circuit.

7. A battery pack according to claim 1, wherein the battery pack comprises at least a second battery cell adjacent to said first battery cell, and wherein the abutting surface is formed by said second battery cell, so that the at least one expansion sensor is arranged between said first battery cell and said second battery cell.

8. A battery pack according to claim 1, wherein the abutting surface if formed by an inner wall of said housing.

9. A battery pack according to claim 1, wherein said detection circuit is configured to determine a DC resistance of said at least one inductor circuit.

10. A battery pack according to claim 3, wherein said detector circuit is configured to, in a first mode of operation, individually detect a change in inductance of at least two flat inductor circuits of said plurality of flat inductor circuits and to, in a second mode of operation, detect a capacitance change between said at least two flat inductor circuits of said plurality of flat inductor circuits.

11. A battery pack according to claim 1, wherein the flexible substrate is made for the most part from a planar foil of plastic material that is selected from a group of plastic materials formed by polyethylene terephthalate PET, polyimide PI, polyetherimide PEI, polyethylene naphthalate PEN, polyoxymethylene POM, polyamide PA, polyphthalamide PPA, polyether ether ketone PEEK, and combinations of at least two of these plastic materials.

12. A battery pack according to claim 1, wherein the first compressible buffer layer and/or the second compressible buffer layer comprises a compressible foam with a magnetic filler material.

13. A method for at least one of detecting upcoming thermal runaway, supporting the evaluating of a state of safety, and supporting the evaluating of a state of health of a battery according to claim 1, comprising at least the following steps:
detecting an expansion of a battery cell and/or a displacement of the outer shell of a battery cell, wherein said detecting an expansion of said battery cell and/or a displacement of the outer shell of said battery cell comprises at least the step of detecting a change in inductance of at least one flat inductor circuit of said at least one expansion sensor by said detection circuit;
evaluating at least one of a status of an upcoming thermal runaway, a state of safety, and a state of health of the battery pack based on at least said expansion of said first battery cell and/or displacement of the outer shell of said first battery cell.

14. The method according to claim 13, wherein said detecting an expansion of said battery cell and/or a displacement of the outer shell of said battery cell further comprises the steps of:
individually detecting a change in inductance of at least two flat inductor circuits; and
detecting a capacitance change between said at least two flat inductor circuits.

15. The method according to claim 13, when the least one expansion sensor further comprises two conductive electrode pads arranged adjacent to each other on said flexible substrate in said contact zone between the battery cell and said abutting surface, said detecting an expansion of said battery cell and/or a displacement of the outer shell of said battery cell further comprises the step of detecting a capacitance change between said electrode pads and/or a capacitance change between one of said electrode pads and said at least one flat inductor circuit.

16. The method according to claim 13, wherein said detecting an expansion of said battery cell and/or a displacement of the outer shell of said battery cell further comprises the step of determining a DC resistance of said at least one inductor circuit.
